(19) United States
(12) Patent Application Publication
(10) Pub. No.: US 2025/0084569 A1
(43) Pub. Date: Mar. 13, 2025

(54) PLANAR HEAT-GENERATING KNIT AND PLANAR HEAT-GENERATING ELEMENT

(71) Applicant: SEIREN CO., LTD., Fukui (JP)

(72) Inventors: Itsusei MITSUI, Fukui (JP); Kosuke MIYAZAKI, Fukui (JP)

(21) Appl. No.: 18/825,106

(22) Filed: Sep. 5, 2024

(30) Foreign Application Priority Data
Sep. 8, 2023 (JP) 2023-146313

(51) Int. Cl. D04B 21/20; H05B 3/34

(52) U.S. Cl. CPC D04B 21/202; H05B 3/345; D10B 2101/20; D10B 2401/16

(57) ABSTRACT

Provided is a planar heat-generating knit in which conductive yarns can be installed freely in the knit, which has excellent stretchability and rapid warming property while having fine shape followability against a complex shape of an object to be heated.

A planar heat-generating knit 10 including a knit including a plurality of conductive yarns 100 as a heat-generating part, wherein the knit is knitted by warp knit; and the conductive yarns 100 each include a core yarn 110 and a conductive sheath yarn 120 wound around said core yarn 110; the conductive sheath yarn 120 is a metal wire 121 coated with an insulating resin 122; and the respective conductive yarns 100 included in the knit are arranged so that a difference between a maximum separation distance and a minimum separation distance between the adjacent conductive yarns 100 is from 0 mm to 14 mm.

### TECHNICAL FIELD

The present invention relates to a planar heat-generating knit having a knit including a plurality of conductive yarns as a heat-generating part, and a planar heat-generating element including an electrode provided on said planar heat-generating knit.

### BACKGROUND ART

Planar heat-generating elements are widely used, for example, in the interior of vehicles, clothing, health, nursing care and medical instruments, furniture, etc.

As a planar heat-generating element of this type, there has traditionally been one formed by laminating a support layer and a metal layer (see, for example, Patent Literature 1).

The planar heat-generating element described in Patent Literature 1 is formed by sputtering copper onto a surface of a polyester nonwoven fabric and attaching an electrode thereto. This planar heat-generating element has flexibility to some extent because it is based on a polyester nonwoven fabric.

Furthermore, as a planar heat-generating element having stretchability, a planar heat-generating knit having a knit including conductive yarns as a heat-generating part on which an electrode is disposed (see, for example, Patent Literature 2).

The planar heat-generating element described in Patent Literature 2 is knitted by multiple knit using conductive yarns for connecting yarns connecting a superficial tissue and a rear tissue, wherein the superficial tissue and the rear tissue are formed into a weft-knitted tissue. This planar heat-generating element can well follow the shape of an object to be heated and can deform due to the stretchability of the weft-knitted tissue, and as a result, the object to be heated can be heated efficiently in a short time.

### CITATION LIST

### Patent Literature

Patent Literature 1: WO 2016/024610
Patent Literature 2: WO 2021/124037

### SUMMARY OF INVENTION

### Technical Problem

Incidentally, there are some objects to be heated having complex shapes. In recent years, the use of planar heat-generating elements has been diversified, and planar heat-generating elements are increasingly installed not only on flat surfaces, but also on curved parts and uneven and convex parts, etc. of objects to be heated. According to this, planar heat-generating elements are required to have shape followability that enables planar heat-generating elements to follow various shapes. Furthermore, planar heat-generating elements using a metal wire for a conductive yarn are also required to have a characteristic to generate heat in a short time (rapid warming property).

However, the planar heat-generating element in Patent Literature 1 originally has poor stretchability of the polyester nonwoven fabric, and further, since copper is formed into a film on the surface of the polyester nonwoven fabric, the stiffness of the planar heat-generating element is increased, and thus it is difficult to say that the planar heat-generating element has good shape followability with an object to be heated having a complex shape.

In order to efficiently heat an object to be heated in a short time, it is necessary to allow a planar heat-generating element to finely adhere to the object to be heated. In this regard, since the planar heat-generating element of Patent Literature 2 is a weft-knitted tissue, the conductive yarns can only be arranged in parallel, and if the object to be heated has a complex shape, it is difficult to arrange the conductive yarns along said shape, and thus it is difficult to say that the rapid warming property is fine. Furthermore, if the planar heat-generating element is cut into a complex shape according to the shape of the object to be heated with the conductive yarns arranged in parallel, there is a risk that the conductive yarns may be broken. Moreover, when an electrode is provided on the planar heat-generating knit, it is necessary to remove the insulating yarns around the conductive yarns by melting with a laser, etc. However, there is a risk that the insulating yarns around the electrode installation area is shrunk by heat to reduce the stretchability of the knit as a whole.

The present invention has been made in view of the above problems, and aims to provide a planar heat-generating knit in which conductive yarns can be arranged freely in the knit, which has excellent stretchability and rapid warming property while having good shape followability against a complex shape of an object to be heated. Furthermore, the object of the present invention is to provide a planar heat-generating element that does not reduce the stretchability of a planar heat-generating knit when an electrode is provided on the knit.

### Solution to Problem

The feature and configuration of the planar heat-generating knit according to the present invention for solving the above-mentioned problem includes:
a planar heat-generating knit including a plurality of conductive yarns as a heat-generating part, wherein
   the knit is knitted by warp knit; and
   the conductive yarns each include a core yarn and a conductive sheath yarn wound around said core yarn, the conductive sheath yarn is a metal wire coated with an insulating resin; and
   the respective conductive yarns included in the knit are arranged such that a difference between a maximum separation distance and a minimum separation distance between the adjacent conductive yarns is from 0 mm to 14 mm.

According to the planar heat-generating knit of this configuration, a knit including a plurality of conductive yarns is used as a heat-generating part, and since said knit is knitted by warp knit, the conductive yarns can be arranged freely in the knit. Accordingly, even if the object to be heated has a complex shape, if the conductive yarns are arranged in the knit so as to conform to said shape, the conductive yarn can approach or closely adhere to the surface of the object to be heated due to the fine shape followability and stretchability of the knit, and thus the object can be rapidly heated. Furthermore, by arranging the conductive yarn according to the shape of the object to be heated in advance, it is possible to avoid breaking of the conductive yarn when cutting the knit into a complex shape. In addition, since the conductive sheath yarn is a metal wire coated with an insulating resin, the metal wire is protected, and thus a planar heat-generating knit having excellent bending durability can be realized. Furthermore, since the respective conductive yarns included in the knit are arranged so that a difference between a maximum separation distance and a minimum separation distance between the adjacent conductive yarns is from 0 mm to 14 mm, the conductive yarns are less biased, and the number of the conductive yarns per unit area is sufficiently secured. Therefore, a planar heat-generating knit with having excellent rapid warming property can be realized.

In the planar heat-generating knit according to the present invention,
the maximum separation distance between the adjacent conductive yarns is preferably 18 mm or less.

According to the planar heat-generating knit of this configuration, since the maximum separation distance between the adjacent conductive yarns is 18 mm or less, the number of the conductive yarns per unit area is sufficiently secured, and thus a planar heat-generating knit having excellent rapid warming property can be realized.

In the planar heat-generating knit according to the present invention,
the knit preferably has a resistance value per unit area of from 15 to 25 (Ω/m²).

According to the planar heat-generating knit of this configuration, by setting the resistance value per unit area of the knit to 15 to 25 (Ω/m²), the temperature rise rate of the heat-generating part is increased, and thus a planar heat-generating knit having excellent rapid warming property can be realized.

In the planar heat-generating knit according to the present invention,
it is preferable to have a normal part in which the conductive yarns are arranged in parallel with respect to the longitudinal direction of the knit and a convex part in which the conductive yarns are arranged in a staggered manner.

According to the planar heat-generating knit of the present configuration, by having a normal part in which the conductive yarns are arranged in parallel with respect to the longitudinal direction of the knit and a convex part in which the conductive yarns are arranged in a staggered manner, even if the object to be heated has a complex shape, the conductive yarns contained in the planar heat-generating knit can be close or tightly adhered to the surface of the object to be heated due to the free arrangement of the conductive yarns and the fine shape followability and stretchability of the knit.

In the planar heat-generating knit according to the present invention,
it is preferable that the warp knit is Denby knit, code knit, Atlas knit, half knit, satin knit, tricot knit, fleecy knit, jacquard knit, or a combination thereof.

According to the planar heat-generating knit of this configuration, since the warp knit is Denby knit, code knit, Atlas knit, half knit, satin knit, tricot knit, fleecy knit, jacquard knit, or a combination thereof, a planar heat-generating knit having excellent shape followability and stretchability can be provided.

The feature and configuration of the planar heat-generating element according to the present invention for solving the above-mentioned problem includes:
a planar heat-generating element including one of the above-mentioned planar heat-generating knits and an electrode, wherein
   the conductive yarns are not inserted into the planar heat-generating knit in an area in which the electrode is to be installed in the knit.

According to the planar heat-generating element of the present configuration, since the planar heat-generating knit of the present invention is used, even if the object to be heated has a complex shape, the shape followability and stretchability against said object to be heated are fine, and as a result, the conductive yarns are close or tightly attached to the surface of the object to be heated. Therefore, a planar heat-generating element with excellent rapid warming property can be realized. Here, since the conductive yarns are not inserted into the knit in the planar heat-generating element in the area where the electrode is installed in the planar heat-generating knit, it is not necessarily necessary to melt and remove the insulating yarns with laser, etc. to attach the electrode, and reduction in the stretchability of the knit as a whole due to heat can be avoided. In addition, since the conductive yarns are not inserted into the knit, even if the area to which the electrode is attached is removed, it is sufficient to cut only the insulating yarns, and the working process can be simplified more than removing the insulating yarns by melting with a laser, etc.

In the planar heat-generating element according to the present invention,
the conductive yarns that are not inserted into the knit are preferably in a state that they are separated from a surface of the knit.

According to the planar heat-generating element of this configuration, since the conductive yarns that are not inserted into the knit are in a state that they are separated from the surface of the knit, the electrode can be easily attached to the conductive yarns without removing the area to which the electrode is to be attached.

In the planar heat-generating element according to the present invention,
it is preferable that the knit has been removed in the area where the electrode is to be installed in the planar heat-generating knit.

According to the planar heat-generating element of this configuration, since the knit has been removed in the area where the electrode is to be installed in the planar heat-generating knit, the electrode can be easily attached to the conductive yarn.

In the planar heat-generating element according to the present invention,
it is preferable that the conductive sheath yarns are treated so that the metal wires are exposed in the area in which the electrode is to be installed in the planar heat-generating knit.

According to the planar heat-generating element of this configuration, since the conductive sheath yarns are treated so that the metal wires are exposed in the area where the electrode is to be installed in the planar heat-generating knit, the short circuit of the adjacent conductive yarns outside the area where the electrode is installed is prevented by the insulating resin while ensuring an energized state between the electrode and the conductive sheath yarns. Therefore, excellent rapid warming property and high safety can be achieved simultaneously.

### BRIEF DESCRIPTION OF DRAWINGS

FIG. 1 is a perspective view schematically illustrating the planar heat-generating element according to an embodiment of the present invention;

Each of FIGS. 2A, 2B, 2C and 2D is an illustrative view of the vicinity of the area where the electrode is to be installed of the planar heat-generating element, wherein FIG. 2A is a state before removal of the knit, FIG. 2B is a state after removal of the knit, FIG. 2C is a state in which the electrode is attached to the conductive yarn, and FIG. 2D is a state in which an unnecessary end has been removed, respectively;

FIG. 3 is a plan view of the planar heat-generating knit used for the planar heat-generating element, and a partially enlarged view thereof;

Each of FIGS. 4A and 4B is a tissue drawing of the planar heat-generating knit, wherein FIG. 4A is a tissue drawing of the part corresponding to the part X of FIG. 3, and FIG. 4B is a tissue drawing of the part corresponding to the part Y of FIG. 3;

FIG. 5 is an illustrative view illustrating a detailed configuration of the conductive yarns; and

Each of FIGS. 6A and 6B is an illustrative view showing the diameters of the conductive yarn and the insulating yarn, wherein FIG. 6A is a cross-sectional view of the conductive yarn, and FIG. 6B is a cross-sectional view of the insulating yarn.

### BEST MODE FOR CARRYING OUT INVENTION

The planar heat-generating knit and planar heat-generating element of the present invention will be described with reference to the drawings. However, the configuration (knit tissue) shown in each drawing is exaggerated or simplified as appropriate to make the explanation easy, and the size relationship and scale relationship of the yarns included in the knit tissue does not always accurately reflect the actual planar heat-generating knit and planar heat-generating element.

### <Planar Heat-Generating Element>

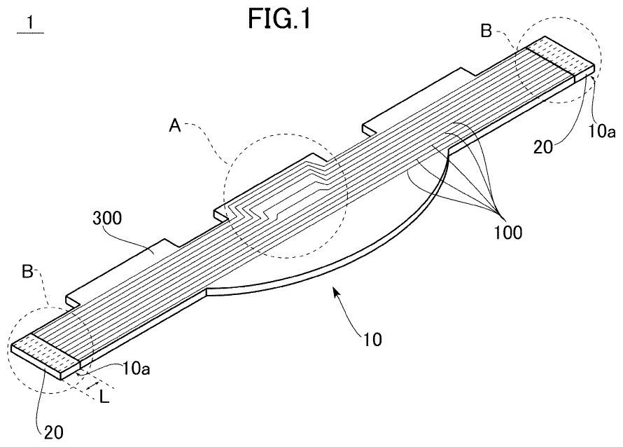

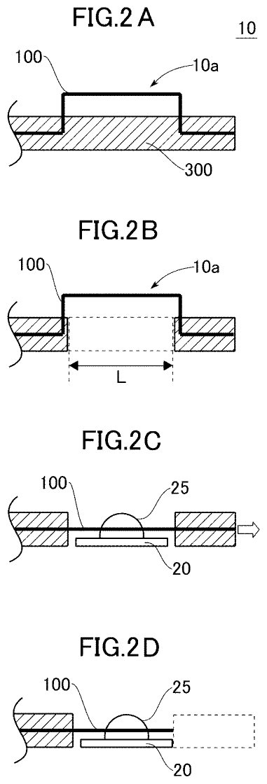

FIG. 1 is a perspective view schematically illustrating the planar heat-generating element 1 according to the present invention; The planar heat-generating element 1 heats an object to be heated (not illustrated) by contacting with or approaching said object to be heated. The planar heat-generating element 1 is a planar heat-generating knit 10 according to the present invention, which will be described in detail later, in which electrodes 20 are respectively provided on two installation areas 10a that are separated in the wale direction (longitudinal direction). The planar heat-generating knit 10 has a warp knitted tissue, and conductive yarns 100 are inserted along the wale direction (longitudinal direction). Here, examples of the warp knit include Denby knit, code knit, Atlas knit, half knit, satin knit, tricot knit, fleecy knit, jacquard knit, etc. The planar heat-generating knit 10 can freely set the arrangement of the conductive yarns 100 in the knit by devising a method of inserting the conductive yarns 100. For example, assuming that the object to be heated is bulging, the conductive yarns 100 in the dashed circle A shown in FIG. 1 are arranged so that they are shifted by one to several courses along the bulging part. Also, since the conductive yarns 100 in the dashed circle B are an installation area 10a for the electrode 20, they are arranged so that the conductive yarns 100 are not inserted into the knit. In this way, in the planar heat-generating element 1, even if the object to be heated has a complex shape, the conductive yarns 100 contained in the planar heat-generating knit 10 can be close to or tightly adhered to the surface of the object to be heated due to the free arrangement of the conductive yarns 100 and the fine shape followability and stretchability by the knit. Incidentally, the method for inserting the conductive yarns 100 may be in a form in which the conductive yarns 100 are just passed through any loops of the warp knitted tissue, or in a form in which the conductive yarns 100 are woven into the warp knitted tissue.

Each of FIGS. 2A, 2B, 2C and 2D is an illustrative view of the vicinity of the area where the electrode is to be installed of the planar heat-generating element, wherein FIG. 2A is a state before removal of the knit, FIG. 2B is a state after removal of the knit, FIG. 2C is a state in which the electrode is attached to the conductive yarn, and FIG. 2D is a state in which an unnecessary end has been removed, respectively. As shown in FIG. 2A, the planar heat-generating element 1 is in a state in which the conductive yarn 100 is not inserted into the knit in the installation area 10a of the electrode 20 in the planar heat-generating knit 10, and thus the conductive yarn 100 is in a state that they are separated from the knit. Therefore, the electrode 20 can be attached to the conductive yarn 100 without melting a knit 300 including the insulating yarn 301 described later in the installation area 10a of the electrode 20 with a laser, etc. In this way, since the removal of the insulating yarn 301 is not necessarily necessary in the present invention, reduction in the stretchability of the knit due to heat can be avoided. However, for the reason that the conductive yarn 100 can be easily attached to the electrode 20, it is preferable that the knit 300 is removed in the installation area 10a for the electrode 20 in the planar heat-generating knit 10, as shown in FIG. 2B. Incidentally, in the installation area 10a of the electrode 20, the conductive yarn 100 is not inserted into the knit 300. Therefore, in the case where the area to which the electrode 20 is to be attached is removed, it is necessary to just cut the knit 300, and thus the working process can be simplified than removing the insulating yarn 301 by melting with a laser, etc.

In a state where the knit is not removed, the conductive yarn 100 that has not been inserted into the planar heat-generating knit 10 is preferably in a state that it is separated from the surface of the knit 300, as shown in FIG. 2A. In this case, the conductive yarn 100 is lifted from the surface of the knit 300. Since the conductive yarn 100 that has not been inserted into the planar heat-generating knit 10 is lifter, the electrode can be easily attached. The conductive yarn 100 that has not been inserted is preferably 5 mm or more longer than the width L of the installation area 10a. The yarn length of the conductive yarn 100 that has not been inserted is preferably from 9 to 40 mm, and more preferably from 10 to 19 mm. Since the yarn length of the conductive yarn 100 is within the above-mentioned range, the workability and processability when attaching the electrode 20 are fine.

Furthermore, in the state that the knit 300 is removed, the conductive yarn 100 that has not been inserted into the planar heat-generating knit 10 is preferably relaxed, as shown in FIG. 2B. Here, that the conductive yarn 100 is relaxed indicates a state in which the conductive yarn 100 is apparently deflected, and the conductive yarn 100 is preferably 5 mm or more longer than the width L of the installation area 10a. Since the conductive yarn 100 that has not been inserted into the knit 300 is relaxed, the conductive yarn 100 can be easily attached to the electrode 20. The yarn length of the conductive yarn 100 is preferably from 10 to 40 mm, more preferably from 10 to 20 mm. Since the yarn length of the conductive yarn 100 is within the above-mentioned range, the workability and processability when attaching the electrode 20 are fine.

The width L of the installation area 10a of the electrode 20 in the planar heat-generating knit 10 is preferably from 6 to 26 mm, and more preferably from 7 to 13 mm, for example, in the case where the electrode 20 with a width of 10 mm is attached in the longitudinal direction. Since the width L of the installation area 10a is 6 mm or more, it is easy to attach the electrode 20 to the conductive yarn 100. Furthermore, since the width L of the installation area 10a is 26 mm or less, the conductive yarn 100 has a length that allows easy handling, and thus the processability when attaching the electrode 20 is fine.

The width L of the installation area 10a for the electrode 20 in the planar heat-generating knit 10 is preferably from 0.6 to 2.6 times with respect to the width of the electrode 20, and more preferably from 0.7 to 1.3 times. Since the width L of the installation area 10a is more than 0.6 times the width of the electrode 20, it is easy to attach the electrode 20 to the conductive yarn 100. Furthermore, since the width L of the installation area 10a is 2.6 times or less the width of the electrode 20, the conductive yarn 100 has a length that allows easy handling, and thus the processability when attaching the electrode 20 is fine.

As shown in FIG. 2C, it is preferable that the conductive yarn 100 is attached to the electrode 20 by a solder 25. At this time, if the yarn length of the conductive yarn 100 is excess, the conductive yarn 100 can be attached to the electrode 20 without deflecting the conductive yarn 100 by pulling the knit in the direction of the arrow in FIG. 2C. The method of attaching the conductive yarn 100 to the electrode 20 is not particularly limited, and a conductive tape, etc. can also be used. As shown in FIG. 2D, it is preferable that the end of the planar heat-generating knit 10 to which the electrode 20 is not attached is removed.

As described later, the conductive yarn 100 has a core yarn 110 and a conductive sheath yarn 120 wound around said core yarn 110. The conductive sheath yarn 120 is a metal wire 121 coated with an insulating resin 122. The conductive sheath yarn 120 is preferably treated so that the metal wire 121 is exposed in the installation area 10a for the electrode 20 in the planar heat-generating knit 10. In the case where the conductive yarn 100 is attached to the electrode 20 by soldering, the insulating resin 122 can be removed by the heat of the solder 25. In this way, when the metal wire 121 of the conductive sheath yarn 120 is treated so that the metal wire 121 is exposed in the installation area 10a of the electrode 20 in the planar heat-generating knit 10, an energized state between the electrode 20 and the conductive sheath yarn 120 can be ensured. On the other hand, except for the installation area 10a of the electrode 20, the metal wire 121 is coated with an insulating resin 122, so that short-circuiting of the adjacent conductive yarns 100 is prevented. In this way, by using a conductive sheath yarn 120 in which the metal wire 121 is coated with an insulating resin 122, excellent rapid warming property and high safety can be achieved simultaneously.

The electrode 20 is electrically connected to a plurality of conductive yarns 100 that are parallel to the course direction (latitudinal direction) in each installation area 10a. When a voltage is applied between the two electrodes 20 of the planar heat-generating element 1, joule heat is generated in the conductive yarns 100. Through this, the object to be heated can be heated and kept warm. Typical objects to be heated include, for example, interior equipment for automobiles such as sheets. The planar heat-generating element 1 is arranged to cover the surface of the object to be heated.

### <Planar Heat-Generating Knit>

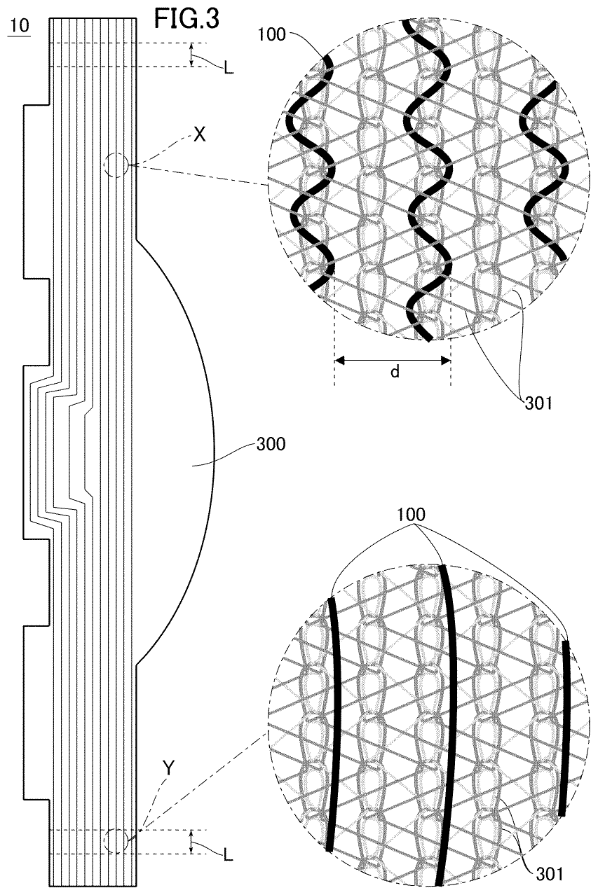

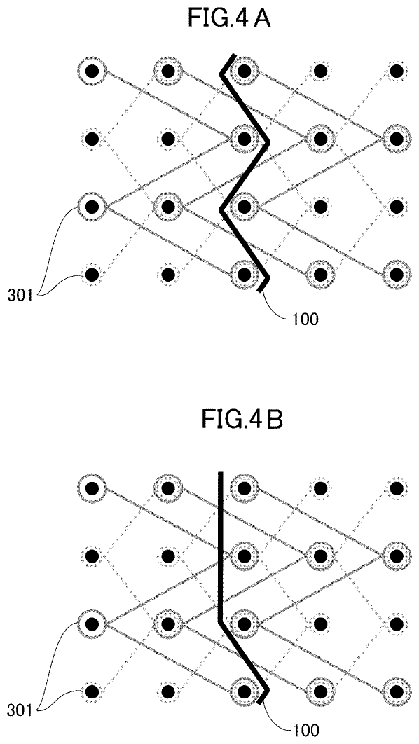

FIG. 3 is a plan view of the planar heat-generating knit 10 used for the planar heat-generating element 1 according to the present invention, and a partially enlarged view thereof. Each of FIGS. 4A and 4B is a tissue drawing of the planar heat-generating knit, wherein FIG. 4A is a tissue drawing of the part corresponding to the part X of FIG. 3, and FIG. 4B is a tissue drawing of the part corresponding to the part Y of FIG. 3. The planar heat-generating knit 10 has a knit including a plurality of conductive yarns 100 as a heat-generating part, and is structured by warp knit. In the present embodiment, the insulating yarn 301 is structured by cord knit and Denby knit, and the conductive yarn 100 is inserted. In the planar heat-generating knit 10, by arranging the conductive yarn 100 according to the shape of the object to be heated in advance, it is possible to avoid breaking of the conductive yarn 100 when cutting the knit along the shape of the object to be heated. The planar heat-generating knit 10 is preferably configured as a single knit. In this case, since the entire knit is thinly configured, the planar heat-generating knit 10 has fine stretchability.

The heat-generating performance of the planar heat-generating element 1 depends on the resistance value of the planar heat-generating knit 10. Therefore, in the present invention, considering the balance between the heat-generating performance and the safety, the resistance value of the planar heat-generating knit 10 is set. The resistance value per unit area of the planar heat-generating knit 10 is preferably from 15 to 25 (Ω/m²), and more preferably from 18 to 20 (Ω/m²). If the resistance value per unit area is 15 (Ω/m²) or more, the heat-generating amount of the planar heat-generating knit 10 is sufficient. If the resistance value per unit area is 25 (Ω/m²) or less, the overheating of the heat-generating part can be suppressed. Furthermore, if the resistance value per unit area of the planar heat-generating knit 10 is within the above-mentioned range, the temperature rise rate of the heat-generating part is large, the rapid warming property is excellent, and thus the planar heat-generating knit 10 is suitable for interior equipment of vehicles such as seat heaters.

In the present embodiment, as shown in the X-part enlarged view of FIG. 3, and FIG. 4A, the insulating yarns 301 are looped and the conductive yarn 100 is inserted so as to hang on the knitted stitches of the insulating yarns 301. In this way, the planar heat-generating knit 10 suppresses the conductive yarn 100 from being irreversibly bent by the conductive yarn 100 being inserted into the insulating yarn 301. As a result, the abnormal heat generation of the planar heat-generating element 1 and the breaking of the conductive yarn 100 are suppressed and the reliability is improved, which contribute to improve the quality.

As shown in the Y-part enlarged view of FIG. 3 and FIG. 4B, in the installation area 10a of the electrode 20, the conductive yarn 100 is not inserted into the knit. That is, in the installation area 10a of the electrode 20, the conductive yarn 100 is not hooked to the knitted stitches of the insulating yarn 301, and is in a state that it is separated from the knit 300. In this way, in the installation area 10a of the electrode 20 in the planar heat-generating knit 10, since the conductive yarn 100 is not inserted into the knit, the insulating yarn 301 can be easily removed by cutting the insulating yarn 301.

In the latitudinal direction, the separation distance d, which is the distance between the adjacent conductive yarns 100, is preferably from 1 to 24 mm, and more preferably from 4 to 16 mm. As shown in FIG. 3, the separation distance d between the conductive yarns 100 means the distance from one conductive yarn 100 to the conductive yarn 100 located next to it. If the separation distance d is within the above-mentioned range, since the conductive yarns 100 are arranged without overlapping and while maintaining an appropriate distance, the rapid warming property of the entire planar heat-generating knit 10 can be further increased. Furthermore, since the conductive yarns 100 can be freely arranged within the knit, the separation distance d between the adjacent conductive yarns 100 may vary depending on the location. The conductive yarns 100 are arranged so that a difference between a maximum separation distance dₘₐₓ and a minimum separation distance dₘᵢₙ between the adjacent conductive yarns 100 is from 0 mm to 14 mm, when the location where the adjacent conductive yarns 100 are disposed furthest apart from each other is a maximum separation distance dₘₐₓ and the location where the conductive yarns 100 are disposed closest to each other is a minimum separation distance dₘᵢₙ. The difference between the maximum separation distance dₘₐₓ and the minimum separation distance dₘᵢₙ between the adjacent conductive yarns 100 is more preferably from 0 to 12 mm. If the difference between the maximum separation distance dₘₐₓ and the minimum separation distance dₘᵢₙ between the adjacent conductive yarns 100 is within the above-mentioned range, the conductive yarns 100 are arranged in the entirety of the planar heat-generating knit 10, and thus the deviation of the heat generated by the planar heat-generating knit 10 is decreased. In addition, since the number of the conductive yarns 100 per unit area is necessarily and sufficiently secured, a planar heat-generating knit having excellent rapid warming property can be realized. Incidentally, if the difference between the maximum separation distance dₘₐₓ and the minimum separation distance dₘᵢₙ between the adjacent conductive yarns 100 is 0 mm, the conductive yarns 100 are inserted in parallel in the longitudinal direction as a whole. If the difference between the maximum separation distance dₘₐₓ and the minimum separation distance dₘᵢₙ between the adjacent conductive yarns 100 is 14 mm or less, the adjacent conductive yarns 100 are inserted while maintaining an appropriate distance. Incidentally, regardless of the heat-generating part of the planar heat-generating knit 10, for example, for those in which the conductive yarns 100 are disposed contrary to the gist of the present invention, such as intentionally disposing only one conductive yarn 100 apart, they shall not be considered for the calculation of the maximum separation distance dₘₐₓ and the minimum separation distance dₘᵢₙ mentioned above.

The planar heat-generating knit 10 is structured by inserting the conductive yarns 100 into the knit 300. The insertion rate of the conductive yarns 100 into the knit 300 can be adjusted by changing a ratio (a:b) between the number (a) of the conductive yarns 100 and the number (b) of the insulating yarns 301 (hereinafter also referred to as the “conductive yarn ratio (a:b)”). By inserting the conductive yarns 100 into the knit 300, the force acting on the conductive yarns 100 during bending of the planar heat-generating knit 10 can be relaxed by the insulating yarns 301, which can suppress a large load on the conductive yarns 100. As a result, the bending durability of the planar heat-generating knit 10 can be increased. The conductive yarn ratio (a:b) is preferably from 1:9 to 1:2, and more preferably from 1:7 to 1:4. If the conductive yarn ratio (a:b) is within the above-mentioned range, the rapid warming property of the entire planar heat-generating knit 10 can be increased while avoiding contact between the conductive yarns 100. If the conductive yarn ratio (a:b) is less than 1:9 (i.e., the number of conductive yarns 100 is relatively small), the heat-generating performance of the planar heat-generating knit 10 is inferior. If the conductive yarn ratio is greater than 1:2 (that is, the number of the conductive yarns 100 is relatively high), there is a risk that the conductive yarns 100 will come into contact with each other.

### <Insulating Yarn>

The forms of the insulating yarn 301 include spun yarns (short fiber yarns), multi-filament yarns, monofilament yarns, etc. Multi-filament yarns may be twisted as needed or subjected to a processing such as false twisting or a fluid disturbance treatment. The fineness (total fineness) of the insulating yarn 301 is preferably from 56 to 330 dₜₑₓ, and more preferably from 56 to 167 dₜₑₓ. The diameter of the insulating yarn 301 is preferably from 72 to 175 μm, more preferably from 72 to 125 μm, and even more preferably from 72 to 88 μm. If the total fineness and diameter of the insulating yarn 301 is within the above-mentioned ranges, the knit has excellent bending durability and surface followability.

The materials of the fibers configuring the insulating yarn 301 are not particularly limited, and can include, for example, natural fibers, recycled fibers, semi-synthetic fibers, synthetic fibers, etc. They can be used alone or in combination of two or more. Among them, from the point of having excellent strength, synthetic fibers are preferred, and polyester fibers such as polyethylene terephthalate are preferred. The shape of the fibers is not particularly limited, and may be either long fibers or short fibers. Furthermore, the cross-sectional shape of each fiber is not particularly limited, and in addition to a normal round shape, the fiber may be of a variant type such as a flat type, an elliptical type, a triangular type, a hollow type, a Y-shaped type, a T-shaped type or a U-shaped type.

### <Conductive Yarn>

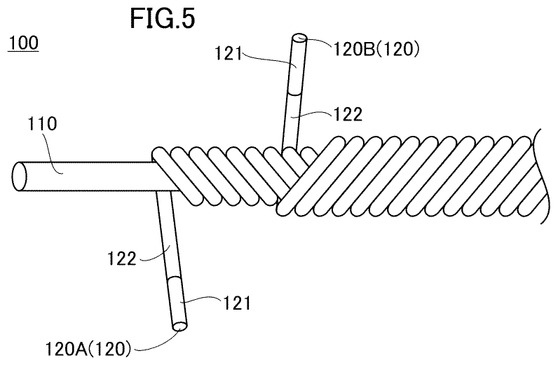

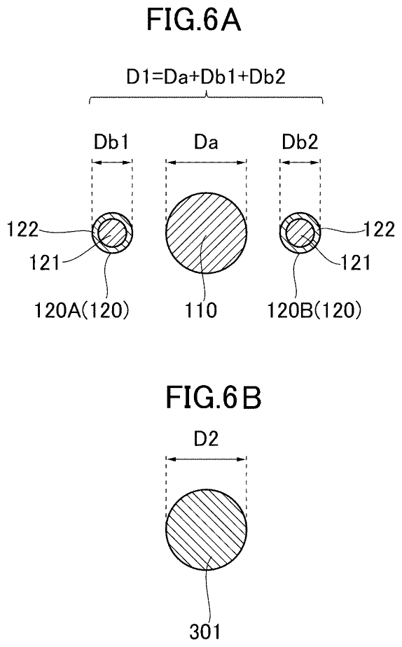

FIG. 5 is an illustrative drawing illustrating a detailed configuration of the conductive yarn 100. The conductive yarn 100 is configured as a covering yarn having a core yarn 110 and a conductive sheath yarn 120 wound around said core yarn 110. The conductive sheath yarn 120 is a metal wire 121 coated with an insulating resin 122. The conductive yarn 100 can be configured as a covering yarn having a core yarn 110 and a conductive sheath yarn 120 to increase the stretchability of the knit. The conductive yarn 100 may be either a single covering yarn with one conductive sheath yarn 120 wound around the core yarn 110 or a double covering yarn with two conductive sheath yarns 120 wound around the core yarn 110, but is preferably a double covering yarn. FIG. 5 illustrates a double covering yarn in which two conductive sheath yarns 120A and 120B are wound around a core yarn 110. If the conductive yarn 100 is such a double-covering yarn, the temperature rise rate of the planar heat-generating knit 10 increases, and thus the rapid warming property is excellent. Furthermore, since the conductive sheath yarn 120 is a metal wire 121 coated with an insulating resin 122, the metal wire 121 is protected, and thus a planar heat-generating knit having excellent bending durability can be realized.

It is preferable to use a monofilament yarn or a multi-filament yarn as the core yarn 110 used for the conductive yarn 100. The fineness of the core yarn 110 is preferably from 22 to 56 dₜₑₓ. Furthermore, the diameter of the core yarn 110 is preferably from 45 to 72 μm. If the fineness and diameter of the core yarn 110 are within the above-mentioned ranges, a planar heat-generating knit 10 having excellent surface following property, bending durability, quality, abrasion resistance, and knitting property can be realized.

The material of the core yarn 110 is preferably a synthetic fiber from the viewpoint of strength. Examples of the synthetic fiber include polyester fibers, and polyethylene terephthalate is particularly preferable.

The conductive sheath yarn 120 has a metal wire 121 and an insulating resin 122 covering the metal wire 121. The diameter of the metal wire 121 is preferably from 20 to 80 μm, and more preferably from 25 to 70 μm. If the diameter of the metal wire 121 is within the above-mentioned range, the planar heat-generating knit 10 has both excellent bending durability and excellent surface following property.

As the material of the metal wire 121, for example, single metals such as aluminum, nickel, copper, titanium, magnesium, tin, zinc, iron, silver, gold, platinum, vanadium, molybdenum, tungsten, chromium, manganese, silicon, lead, bismuth, boron, germanium, arsenic, antimony, tellurium and cobalt, and alloys thereof can be used. Among these, it is preferable to use alloys of copper and nickel, alloys of copper and silicon, and alloys such as nichrome from the viewpoint of appropriate resistance values and economy. It should be noted that, in the conductive sheath yarn 120, it is possible to adopt a carbon fiber instead of the metal wire 121 coated with the insulating resin 122.

The insulating resin 122 protects the metal wire 121, ensures insulation, and prevents the metal wire 121 from breaking due to bending, etc. In the installation area 10a of the planar heat-generating knit 10, the insulating resin 122 uses a material that can be easily removed by laser removal processing (a heat-meltable material), etc. in order to enable the metal wire 121 and the electrode 20 to be electrically conductive. As the material of such an insulating resin 122, synthetic resins are preferable, and from the viewpoint of bending resistance, oil resistance, abrasion resistance and toughness, thermoplastic elastomers (TPE: Thermoplastic Elastomers) are more preferable, and esterimides or polyurethanes are further preferable. Although the polyurethanes include thermoset and thermoplastic polyurethanes, it is also possible to use thermoset polyurethanes. The thickness of the insulating resin 122 is preferably from 4 to 8 μm. If the thickness of the insulating resin 122 is within the above-mentioned range, the bending durability and flexibility of the conductive sheath yarns 120 are suitable.

The conductive sheath yarn 120 preferably has an electrical resistivity of 5×10⁻⁵ Ω·m or less, more preferably 1.5×10⁻⁶ Ω·m or less, and further preferably 5.0×10⁻⁷ Ω·m or less. If the electrical resistivity of the conductive sheath yarn 120 is 5×10⁻⁵ Ω·m or less, when a voltage of 13 V by an on-board battery is applied to the planar heat-generating knit 10 having a size of about 40 cm in the longitudinal direction used for an interior equipment for a vehicle as a seat heater, etc., moderate Joule heat is generated to increase the temperature rise rate of the planar heat-generating knit 10, and thus the rapid warming property is excellent.

### <Diameter (D1) of Conductive Yarn and Diameter (D2) of Insulating Yarn>

Each of FIGS. 6A and 6B is an illustrative view showing the diameters of the conductive yarn 100 and the insulating yarn 301, wherein FIG. 6A is a cross-sectional view of the conductive yarn 100, and FIG. 6B is a cross-sectional view of the insulating yarn 301. Here, in the conductive yarn 100, depending on the aspect in which the conductive sheath yarn 120 is stacked on the core yarn 110, the degree of adhesion between them is different. As a result, the diameter of the conductive yarn 100 configured by the core yarn 110 and the conductive sheath yarn 120 may be variously different. In the conductive yarn 100 shown in FIG. 5, the two conductive sheath yarns 120 are wound around the core yarn 110. Therefore, as shown in FIG. 6A, the diameter (D1) of the conductive yarn 100 is defined as the diameter (Da) of the core yarn 110, and the diameter (Db1) of one conductive sheath yarn 120A (inner side here) and the diameter (Db2) of the other conductive sheath yarn 120B (outer side here) of the two conductive sheath yarns 120 (D1=Da+Db1+Db2). Furthermore, the diameter (Da) of the core yarn 110 and the diameter (Db) of the conductive sheath yarn 120 are the respective maximum diameters, and the diameter (Db) of the conductive sheath yarn 120 is the sum of the diameter of the metal wire 121 and the thickness (×2) of the insulating resin 122.

The diameter (D2) of the insulating yarn 301 is its maximum diameter, as shown in FIG. 6B.

### <Electrode>

The electrode 20 is configured as a film such as a conductive film formed by depositing a metal on a surface of a resin film such as a polyimide film, a metal foil, or a film with a metal foil attached thereto. The electrode 20 is attached to each of two installation areas 10a provided spaced apart in the latitudinal direction in the planar heat-generating knit 10. In the installation area 10a, the conductive sheath yarn 120 wound around the core yarn 110 of the conductive yarn 100 is treated so that the insulating resin 122 on the surface of the conductive sheath yarn 120 is removed with the core yarn 110 by laser removal processing, etc., and the coil-like metal wire 121 is exposed. Accordingly, in the installation area 10a, the electrode 20 is electrically connected to the conductive yarn 100. As the metal to be deposited on the resin film, for example, single metals such as aluminum, nickel, copper, titanium, magnesium, tin, zinc, iron, silver, gold, platinum, vanadium, molybdenum, tungsten, chromium, manganese, silicon, lead, bismuth, boron, germanium, arsenic, antimony, tellurium, and cobalt, and alloys thereof can be used. Among these, copper is preferably used.

### EXAMPLES

Planar heat-generating knits each having the characteristic configuration of the present invention (Examples 1-7) were made, and measurements and evaluations were carried out. Furthermore, for comparison, planar heat-generating knits not having the characteristic configuration of the present invention (Comparative Examples 1 and 2) were made, and similar measurements and evaluations were carried out. The measurement and evaluation items were rapid warming property, processability, bending durability, and surface followability. Each item will be explained below.

### [Rapid Warming Property]

The rapid warming property was measured by the following procedure. A test specimen of 110 cm in the longitudinal direction and 10 cm in the latitudinal direction was collected from the planar heat-generating knit, and an electrode composed of a 10 cm×1 cm copper foil was attached to each of the installation areas of the electrode, from which the insulating yarns in the installation areas had been removed by cutting, to form a planar heat-generating element. For heat insulation, the planar heat-generating element was placed on a 10 mm-thick urethane foam, the test specimen was covered with a synthetic leather (trade name: QUOLE, manufactured by Seiren Co., Ltd., thickness: 1 mm), and the temperature of the surface of the synthetic leather on a normal part (conductive yarn parallel part) was measured by a thermography (product number: G100, manufactured by Nippon Avionics Co., Ltd.). This test specimen was placed under an environment of 25° C. and a voltage of 12 V was applied between the electrodes, and the temperature change after 30 seconds was recorded. Furthermore, the rapid warming property was evaluated by the following evaluation criteria. The surface temperature was measured three times, and the average value thereof was adopted.
+: Temperature rise of 10° C. or more
−: Temperature rise of less than 10° C.

Furthermore, the rapid warming property of the convex part (the bent part of the conductive yarn) was also evaluated by the following evaluation criteria.
+: Temperature rise of 80% or more of the normal part
−: Temperature rise of less than 80% of the normal part [Processability]

The yarn lengths of the conductive yarns in the electrode-installed area were measured. Furthermore, the processability of the electrode with a width of 10 mm when it was attached was evaluated by the following evaluation criteria.
+: 10 mm or more and less than 20 mm
−: less than 10 mm or 20 mm or more

### [Bending Durability]

A test specimen of 25 mm in the longitudinal direction and 200 mm in the latitudinal direction was collected from the planar heat-generating knit, and the test specimen was repeatedly bent in the middle of the latitudinal direction so that the both ends in the latitudinal direction were fit. Each time the test specimen was bent 1000 times, the presence or absence of breaking of the metal wire was confirmed by an energization test. Furthermore, the bending durability was evaluated by the following evaluation criteria.
+: No breaking occurred when the number of bends was 10,000.
−: Breaking occurred when the number of bends was less than 10,000.

### [Surface Followability]

The planar heat-generating knit was fixed along the surface of a trapezoidal box, and the lifting of the fabric from the surface of the box and the presence or absence of wrinkles were visually observed. Furthermore, the surface followability was evaluated by the following evaluation criteria.
++: No lifting and wrinkles of the fabric were observed.
+: Wrinkles were observed, but lifting of the fabric was not observed.
−: The fabric was lifted from the surface of the box.

### Example 1

A conductive yarn shown in Table 1 was obtained by double covering at a number of windings of 300 (times/m) using a polyethylene terephthalate yarn of 22 dₜₑₓ/1f (manufactured by SUNCORONA ODA co., ltd) as a core yarn, and using a Cu/Si alloy metal wire with a diameter of 50 μm coated with a polyurethane (thickness: 6 μm) as a conductive sheath yarn.

A jacquard knit (warp knit) with a course density of 32 and a wale density of 25 was structured by using a polyethylene terephthalate yarn of 84 dₜₑₓ/36f (manufactured by San-etsu Co., Ltd.) as an insulating yarn, and using a 24 gauge knitting machine (manufactured by KARL MAYER). In this structuring, the conductive yarn obtained above was inserted. In this insertion, the ratio (a:b) between the number (a) of the conductive yarns and the number (b) of the insulating yarns was 1:4. Furthermore, the width of the electrode installation area was set to 10 mm. The difference between the maximum separation distance and the minimum separation distance between the adjacent conductive yarns was set to 2 mm. In this way, the planar heat-generating knit of Example 1 having the configuration shown in Table 1 was obtained. The area of this planar heat-generating knit was 0.12 m², and the resistance value was 2.4Ω. Accordingly, the resistance value per unit area of the planar heat-generating knit of Example 1 is 20.0 Ω/m².

### Examples 2-7, Comparative Examples 1 and 2

The fineness (i.e., diameter) of the core yarn in the conductive yarn, the material and diameter of the metal wire in the conductive sheath yarn, the electrical resistivity of the conductive sheath yarn, the material and fineness (i.e., diameter) of the insulating yarn, the difference between the maximum separation distance and minimum separation distance between the adjacent conductive yarns, the ratio (a/b) between the number (a) of the conductive yarns and the number (b) of the insulating yarns, and the width of the electrode installation area were set as shown in Table 1, and the planar heat-generating knits of Examples 2-7 and Comparative Examples 1 and 2 were obtained in the same manner as that of Example 1.

Table 1 shows the planar heat-generating knits of Examples 1-7, the configurations of the planar heat-generating knits of Comparative Examples 1 and 2, and the measurement and evaluation results.

TABLE 1

| | | | Example 1 | Example 2 | Example 3 | Example 4 | Example 5 |
|---|---|---|---|---|---|---|---|
| Conductive | Conductive | Metal wire material | Cu/Si alloy | Cu/Si alloy | Cu/Si alloy | Cu/Si alloy | Cu/Zn alloy |
| yarn | sheath yarn | Diameter of metal wire (μm) | 50 | 50 | 50 | 50 | 50 |
| | | Resin material | PU | PU | PU | PU | PU |
| | | Thickness of resin (μm) | 6 | 6 | 6 | 6 | 6 |
| | | Covering | Double | Double | Double | Double | Single |
| | | Electrical resistivity ( [symbol] ) | 4.98 | 4.98 | 4.98 | 4.98 | 1.80 |
| | Core yarn | Material | PET | PET | PET | PET | PET |
| | | Fineness (dtex) | 22 | 22 | 22 | 22 | 22 |
| Insulating | Material for insulating yarn | | PET | PET | PET | PET | PET |
| yarn | Fineness (dtex) of insulating yarn | | 84 | 84 | 84 | 84 | 84 |
| | Diameter ( [symbol] ) ( [symbol] ) of insulating yarn | | 8 [symbol] | 8 [symbol] | 8 [symbol] | 8 [symbol] | 8 [symbol] |
| Maximum separation distance ( [symbol] ) between conductive yarns | | | 6 | 8 | 12 | 16 | 18 |
| Minimum separation distance ( [symbol] ) [symbol] conductive yarns | | | 4 | 4 | 4 | 4 | 6 |
| Difference between maximum separation | | | 2 | 4 | 8 | 12 | 12 |
| distance and minimum separation distance ( [symbol] ) | | | | | | | |
| Number ration (a/b) | | | 1/4 | 1/4 | 1/4 | 1/4 | 1/6 |
| Electrode installation area width ( [symbol] ) | | | 10 | 10 | 10 | 10 | 10 |
| Resistance value per unit area ( [symbol] ) of | | | 20.0 | 20.3 | 20.3 | 20.4 | 18.8 |
| planar heat-generating unit | | | | | | | |
| Rapid warming | Normal part | Temperature rise (° C.) | 12.1 | 12.1 | 12.0 | 12.0 | 11.9 |
| property | | Judgement | + | + | + | + | + |
| | Convex part | Temperature rise (° C.) | 12.0 | 11.9 | 13.5 | 11.0 | 10.4 |
| | | Temperature rise ratio (%) | 99.2 | 88.3 | 95.8 | 83.7 | 82.8 |
| | | compared to normal part | | | | | |
| | | Judgement | + | + | + | + | + |

| Processability | Yarn length (mm) | 16 | 16 | 16 | 16 | 16 |
|---|---|---|---|---|---|---|
| | Judgement | + | + | + | + | + |
| Bending durability | Number of bendings (times) | 30,000? | 30,000? | 30,000? | 30,000? | 100 |
| | Judgement | + | + | + | — | + |

| | | | | | |
|---|---|---|---|---|---|
| Surface followability | + | + | + | + | + |

| | | | | | Comparative | Comparative |
|---|---|---|---|---|---|---|
| | | | Example 6 | Example 7 | Example 1 | Example 2 |
| Conductive | Conductive | Metal wire material | Cu/Si alloy | Cu/Si alloy | Cu/Si alloy | Cu/Si alloy |
| yarn | sheath yarn | Diameter of metal wire (μm) | 50 | 50 | 50 | 50 |
| | | Resin material | PU | PU | PU | PU |
| | | Thickness of resin (μm) | 6 | 6 | 6 | 6 |
| | | Covering | Double | Double | Double | Double |
| | | Electrical resistivity ( [symbol] ) | 4.98 | 4.98 | 4.98 | 4.98 |
| | Core yarn | Material | PET | PET | PET | PET |
| | | Fineness (dtex) | 22 | 22 | 22 | 22 |
| Insulating | Material for insulating yarn | | PET | PET | PET | PET |
| yarn | Fineness (dtex) of insulating yarn | | 84 | 84 | 84 | 84 |
| | Diameter ( [symbol] ) ( [symbol] ) of insulating yarn | | 8 [symbol] | 8 [symbol] | 8 [symbol] | 8 [symbol] |
| Maximum separation distance ( [symbol] ) between conductive yarns | | | 16 | 18 | 20 | 24 |
| Minimum separation distance ( [symbol] ) [symbol] conductive yarns | | | 4 | 4 | 4 | 4 |
| Difference between maximum separation | | | 12 | 14 | 16 | 20 |
| distance and minimum separation distance ( [symbol] ) | | | | | | |
| Number ration (a/b) | | | 1/4 | 1/4 | 1/4 | 1/4 |
| Electrode installation area width ( [symbol] ) | | | 20 | 10 | 10 | 10 |
| Resistance value per unit area ( [symbol] ) of | | | 20.4 | 20.4 | 20.4 | 21.4 |
| planar heat-generating unit | | | | | | |
| Rapid warming | Normal part | Temperature rise (° C.) | 12.0 | 12.0 | 12.0 | 11.9 |
| property | | Judgement | + | + | + | + |
| | Convex part | Temperature rise (° C.) | 11.0 | 10.1 | 8.9 | 7.8 |
| | | Temperature rise ratio (%) | 91.2 | 84.2 | 80.8 | 63.6 |
| | | compared to normal part | | | | |
| | | Judgement | + | + | — | — |

| Processability | Yarn length (mm) | 32 | 16 | 16 | 16 |
|---|---|---|---|---|---|
| | Judgement | — | + | + | + |
| Bending durability | Number of bendings (times) | 30,000? | 30,000? | 30,000? | 30,000? |

| | | | | |
|---|---|---|---|---|
| Judgement | + | + | + | + |

| | | | | |
|---|---|---|---|---|
| Surface followability | + | + | + | + |

[symbol]

indicates data missing or illegible when filed

The planar heat-generating knits of Examples 1-7 were arranged so that the difference between the maximum separation distance and the minimum separation distance between the adjacent conductive yarns became 14 mm or less, and all of them had a temperature rise at the normal part of 10° C. or more and a temperature rise at the convex part of 80% or more of that at the normal part, and had excellent rapid warming properties. In particular, the planar heat-generating knits of Examples 1-4 and 6, where the maximum separation distance between the conductive yarns is 16 mm or less, had a temperature rise of the convex part of 90% or more of the normal part, and had excellent rapid warming properties. The planar heat-generating knits of Examples 1-5 and 7 had a yarn length of the conductive yarn in the area where an electrode was to be installed of 10 mm or more and less than 20 mm, and thus had excellent processability. Furthermore, the planar heat-generating knits of Examples 1-4, 6 and 7 had excellent bending durability because the conductive yarns were inserted into the insulating yarns and the strength of the conductive sheath yarns was sufficiently increased by the metal wires being coated with the insulating resin, so that the metal wire was not broken even by 10,000 times of bending. In addition, the planar heat-generating knits of Examples 1-7 all had excellent surface followability. From these results, it is believed that the planar heat-generating knits of Examples 1-7 can be suitably used as a heater covering the surface of an interior equipment of a vehicle such as a seat.

On the other hand, the planar heat-generating knits of Comparative Examples 1 and 2 had a temperature rise of the convex part of less than 80% of that of the normal part, and thus were poor in rapid warming property. Since the planar heat-generating knits of Comparative Examples 1 and 2 were arranged so that the difference between the maximum separation distance and the minimum separation distance between the adjacent conductive yarns became 16 mm or more, it is believed that the number of the conductive yarns per unit area was not sufficiently secured and thus the temperature did not rise.

### INDUSTRIAL APPLICABILITY

The planar heat-generating knit and planar heat-generating element of the present invention can be used, for example, in interior equipment for vehicles such as seat heaters, clothing such as jackets, trousers and gloves, massage chairs, health and medical instruments such as nursing beds, furniture such as chairs and sofas, etc.

### REFERENCE SIGNS LIST

1 Planar heat-generating element
10 Planar heat-generating knit
10a Electrode installation area
20 Electrode
100 Conductive yarn
110 Core yarn
120 Conductive sheath yarn
121 Metal wire
122 Insulating resin
d Separation distance

What is claimed is:

1. A planar heat-generating knit comprising a knit comprising a plurality of conductive yarns as a heat-generating part, wherein
the knit is knitted by warp knit; and
the conductive yarns each comprise a core yarn and a conductive sheath yarn wound around said core yarn,
the conductive sheath yarn is a metal wire coated with an insulating resin; and
the respective conductive yarns included in the knit are arranged so that a difference between a maximum separation distance and a minimum separation distance between the adjacent conductive yarns is from 0 mm to 14 mm.

2. The planar heat-generating knit according to claim 1, wherein the maximum separation distance between the adjacent conductive yarns is 18 mm or less.

3. The planar heat-generating knit according to claim 1, wherein the knit has a resistance value per unit area of from 15 to 25 (Ω/m²).

4. The planar heat-generating knit according to claim 1, which has a normal part in which the conductive yarns are arranged in parallel with respect to a longitudinal direction of the knit and a convex part in which the conductive yarns are arranged in a staggered manner.

5. The planar heat-generating knit according to claim 1, wherein the warp knit is Denby knit, code knit, Atlas knit, half knit, satin knit, tricot knit, fleecy knit, jacquard knit, or a combination thereof.

6. A planar heat-generating element comprising the planar heating knit according to claim 1, and an electrode provided thereon, wherein
the conductive yarns are not inserted into the planar heat-generating knit in an area in which the electrode is to be installed in the knit.

7. The planar heat-generating element according to claim 6, wherein the conductive yarns that are not inserted into the knit are in a state that they are separated from a surface of the knit.

8. The planar heat-generating element according to claim 6, wherein the knit has been removed in the area where the electrode is installed in the planar heat-generating knit.

9. The planar heat-generating element according to claim 6, wherein the conductive sheath yarn has been treated so that the metal wire is exposed in the area in which the electrode is installed in the planar heat-generating knit.
